(19) United States
(12) Patent Application Publication
(10) Pub. No.: US 2005/0222973 A1
(43) Pub. Date: Oct. 6, 2005

(54) Methods and systems for summarizing information

(76) Inventor: Matthias Kaiser, Mountain View, CA (US)

Correspondence Address: Finnegan, Henderson, Farabow,;Garrett & Dunner, L.L.P., 1300 I Street, N.W., Washington, DC, 20005-3315, US

(21) Appl. No.: 10/811,972

(22) Filed: Mar. 30, 2004

(51) Int. Cl. G06F 7/00

(52) U.S. Cl. 707/3

(57) ABSTRACT

Methods and systems are provided for accessing relevant information. Relevant information may be accessed in an electronic database. Methods and systems may receive a document in response to a search query. The search query may be parsed to create a set of relevant words, and relevant segments of the received document may be generated, which reflect the set of relevant words. Methods and systems may generate an intermediary document, including identifications of the relevant segments.

### TECHNICAL FIELD

The present invention generally relates to information retrieval based on a user query and, more particularly, to systems and methods for generating an intermediary page with internal links to relevant information.

### BACKGROUND

The Internet, fueled by the phenomenal popularity of the World Wide Web, has exhibited exponential growth over the past few years. On the Web, the ease of self-publication via user-created “Web pages” has helped generate countless documents on a broad range of subjects, all capable of being displayed to a user with access to the Web.

The large number of documents on the Web makes the search for specific or relevant information a complex and difficult task. To find such information, users often take advantage of search engines to help generate lists of potentially relevant documents. Conventional search engines, however, are often ineffective in providing specific guidance to relevant information, and may exacerbate a the difficulties in locating desired information by providing misleading results that force users to peruse an entire document. In fact, users must often review several documents to find the information of interest. Because typical searches return a large number of documents, users may also not be able to navigate efficiently through all the documents, or even appreciate all the portions of the documents that may be relevant.

### SUMMARY

The present invention is directed to methods and systems that improve access to relevant information. Specifically, a computer-implemented method for accessing relevant information in response to a search query comprises receiving a document in response to the search query; identifying relevant segments of the document reflecting a set of relevant words; and generating an intermediary document including identifications of the relevant segments.

A system consistent with the invention for providing improved access to relevant information comprises an acquisition module for retrieving information relating to a plurality of documents in response to a search query; and a summarizing module for parsing the document into segments, selecting one of the segments as a relevant information point; and generating a intermediary document identifying the selected relevant information point.

The foregoing background and summary are not intended to be comprehensive, but instead serve to help artisans of ordinary skill understand the following implementations consistent with the invention set forth in the appended claims. In addition, the foregoing background and summary are not intended to provide any independent limitations on the claimed invention.

### BRIEF DESCRIPTION OF THE DRAWINGS

The accompanying drawings, which are incorporated in and constitute a part of this specification, show certain aspects of the present invention and, together with the description, help explain some of the principles associated with the invention.

FIG. 1 is an illustration of a traditional search result showing links to a number of documents;

FIG. 2A is a diagram showing the relationship between an intermediary document consistent with the present invention, search results, and document segments;

FIG. 2B is a diagram showing the relationship between another intermediary document consistent with the present invention, search results, and document segments;

FIG. 3A is a diagram of intermediary document 310A of FIG. 2A;

FIG. 3B is a diagram of intermediary document 360 of FIG. 2B;

FIG. 4 is a block diagram of a possible architecture consistent with the present invention;

FIG. 5 is a flowchart of a method of generating and intermediary document consistent with the present invention; and

FIG. 6 is a flowchart of another method of generating an intermediary document consistent with the present invention.

### DETAILED DESCRIPTION

The following description refers to the accompanying drawings, in which, in the absence of a contrary representation, the same numbers in different drawings represent similar elements. The implementations set forth in the following description do not represent all implementations consistent with the claimed invention. Instead, they are merely some examples of systems and methods consistent with the invention.

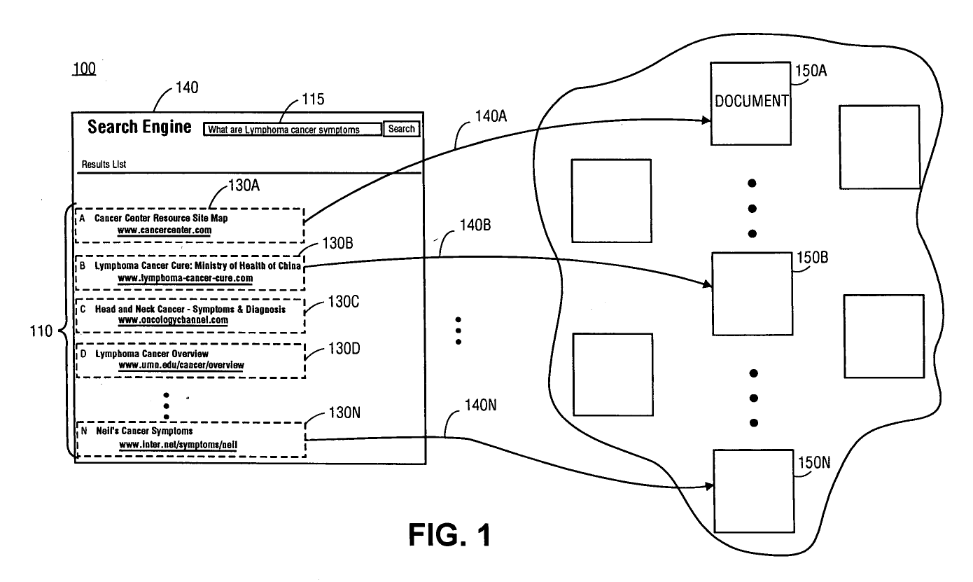

FIG. 1 illustrates a traditional search result containing links to a number of documents. A user may initiate a search for specific information, such as the symptoms of lymphoma, a type of cancer, by submitting a search query 115. The search query may be, for example, a string of characters, words, or phrases, or even a stylized question. For example, the query {What are lymphoma cancer symptoms?} requests the search engine to find documents on lymphoma cancer symptoms. A user provides such search queries 115 to application 140, which may include any type of program or environment designed to perform the necessary functions to carry out the search. Application 140 may include network-based applications, such as interactive Internet web sites, or search engines configured to interact with Internet and other computer applications.

Application 140 parses the search query and searches databases or networks for information relevant to the query. One mechanism application 140 may use is to compare the parsed query with indexes of the content of a given system. The search results 110 may include a list of documents 150A-150N, or references to such documents, relevant to the search query. In searches of network, such as the Internet search, each of the results may be linked to source documents on the network. For example, result 130A may be connected to document 150A through link 140A (e.g., a hypertext link).

At this point in a traditional search, a user is typically presented with a list of search results. Rarely is the user given specific guidance as to which of the results will lead to information most relevant to search query 115.

Methods and systems consistent with the present invention may generate an intermediary document with links to specific locations of information. For example, such methods and systems may parse a document located by a search engine in response to a search query to identify sections or segments of the document with the specific information relevant to the search query. This intermediary document could contain information points with links to relevant parts of the document.

The term “document” does not imply a written form or even a specific electronic form, but instead refers to a collection of links or other identifiers. The term “link” refers broadly to a selectable connection among information objects, such as a hypertext or hypermedia link. The term “link” may also encompass physical and/or logical connections between information objects.

The links to specific functional segments in the document may allow a user to view the specific location of information in the document. This internal referencing limits the number of and improves the quality of the search results which are be viewed by the user.

Embodiments of the present invention may be implemented in connection with various types of web-based search engines, such as the Google® or AltaVitsta® programs. One embodiment will be described with reference to a web-based search engine used by a user of a web browser running on a workstation. In one embodiment, the search engine may display a list of results on the screen of the workstation. The term “search engine,” as used herein, may also include directed web-based search engines, such as those directed to medical information, or software-based search engines, such as a “Find File” program in many operating systems, or the software search engines employed by research tools, such as those developed by Lexis and Westlaw. Furthermore, methods for finding relevant results are not unique to the Web, but may also be used in other contexts or other disciplines.

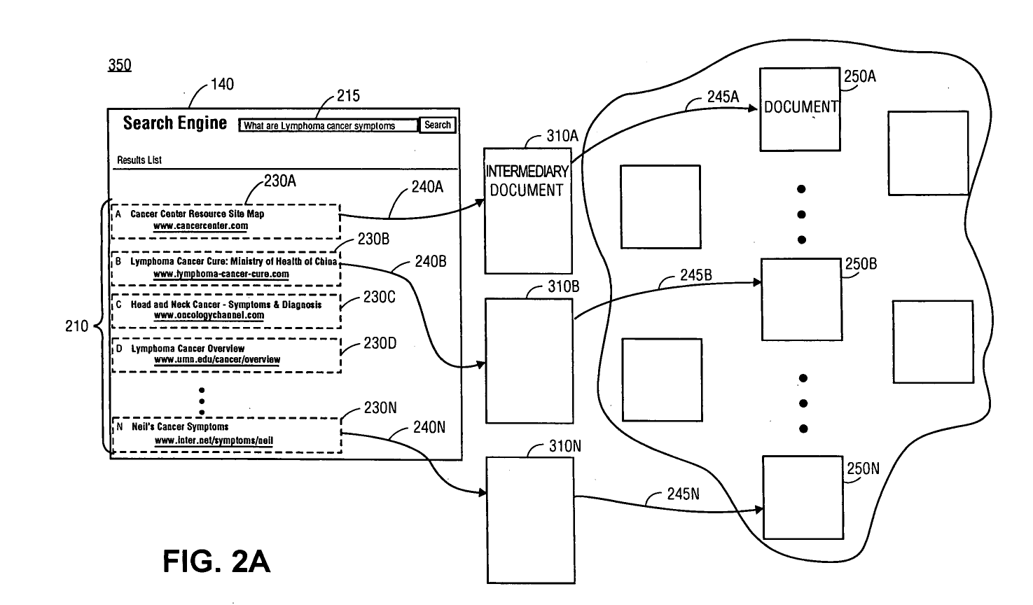

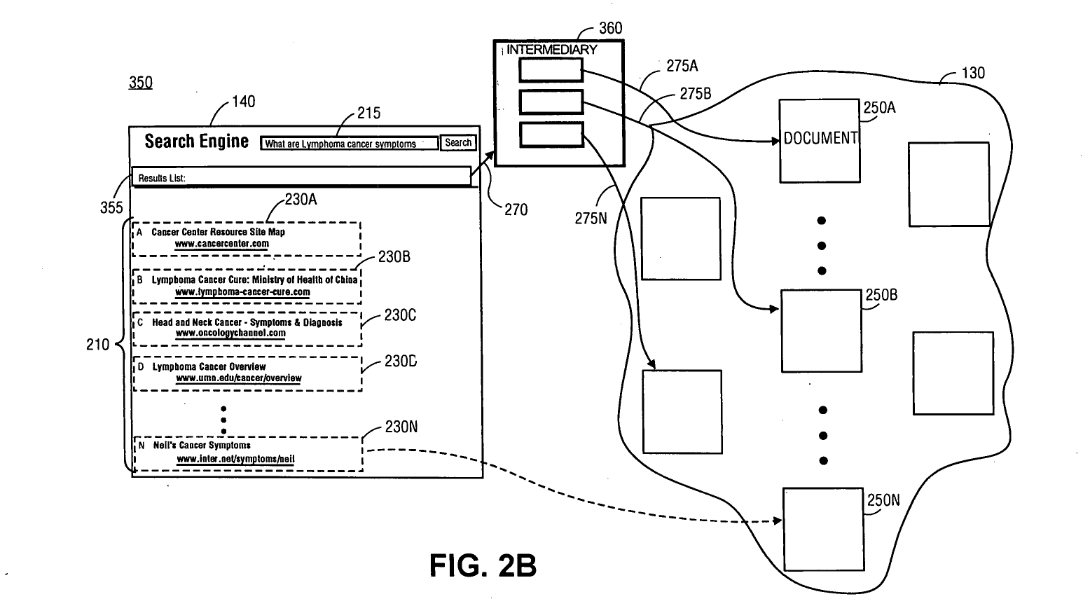

FIGS. 2A and 2B illustrate the relationship between the search results and an original document through an intermediary document, consistent with the present invention. FIG. 2A, for example, illustrates intermediary documents 310A-310N between results 230A-230N and documents 250A-250N identified by a search engine. Result 230A may be linked to summary document 310A via link 240A, which, in turn, may be linked to document 250A via link 245A. Intermediary documents 310A-310N identify the relevant information in documents 250A-250N.

Links 240A-N and 245A-N may include selectable connections, such as hypertext links and hypermedia links. They may also include physical and/or logical connections.

Documents 250A-250N may comprise multiple information objects and/or elements, such as images, text, audio, or other information. Each type of element may be grouped into different segments for review.

FIG. 2B illustrates intermediary document 360 between result list 210 and documents 250A-250N. Result list 210 may be linked to document 360 through link 270, which in turn may be linked to document 250A through link 275A. Intermediary document 360 may be a compilation of the relevant information in documents 250A-250N. Links 270 and 275A-N may be similar to links 240A-N and 245A-N described above.

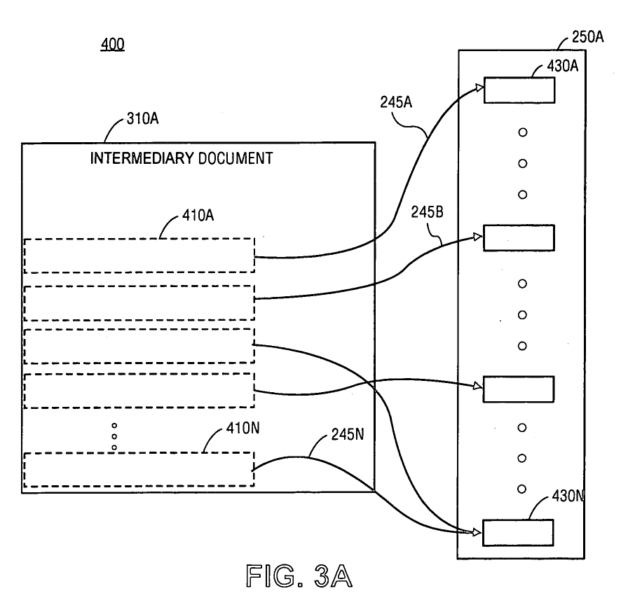

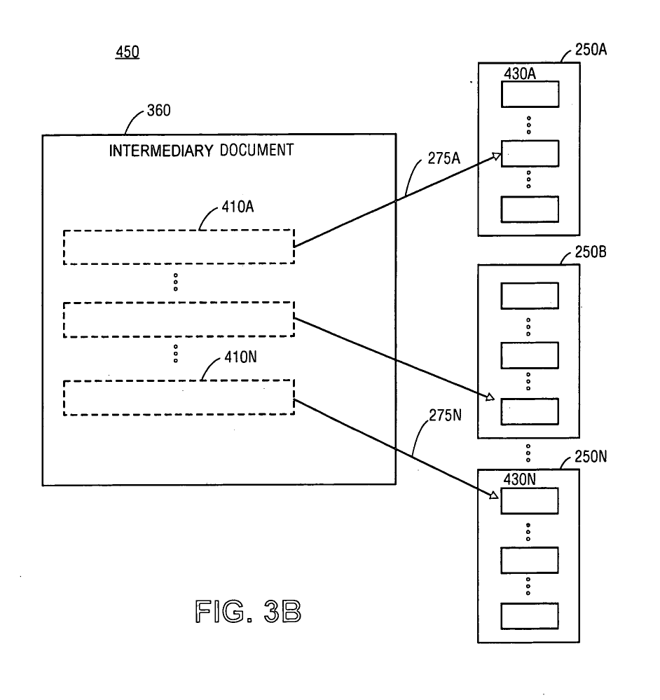

FIG. 3A illustrates in more detail intermediary document 310A from FIG. 2A. Document 310A includes information points 410A-410N. An information point 410 may be a sentence or phrase that offers relevant information. Information point 410A may be a series of natural language sentences from document 250A, or could be a single sentence. Link 420A connects information point 410A to the relevant section or segment of document 250A, such as location 430A of the sentence that makes up information point 410A in document 250A.

FIG. 3B illustrates in more detail intermediary document 360 from FIG. 2B. Intermediary document 360 includes information points 410A-410N, which are linked to relevant sections of documents 250A-250N. Link 420A connects information point 410A to the relevant section of document 250A, such as location 430A of the sentence that makes up information point 410A in document 250A.

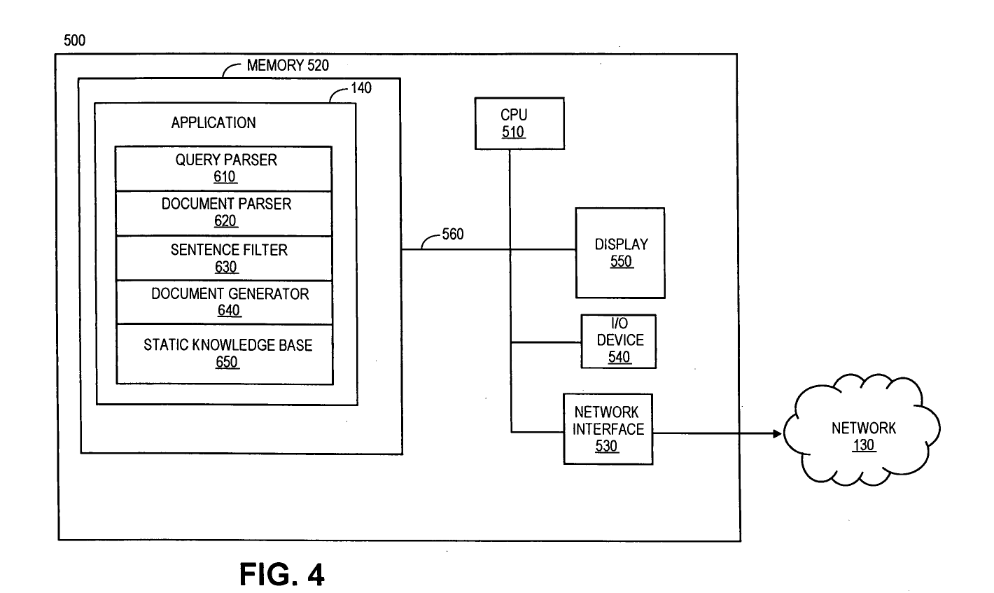

FIG. 4 is a block diagram of an architecture 400 consistent with the present invention. Architecture 400 may comprise a computing system 500 coupled to network 130. The number of components in environment 400 is not limited to what is shown, and other variations in the number of arrangements of components are possible.

Computing system 500 may represent one or more data processing systems capable of running application 140. For example, computing system 500 may include a personal computer, a laptop, a server, a workstation, mobile computing devices (e.g., a PDA), or mobile communication devices (e.g., a cell phone). Computing system 500 could also include a kiosk or terminal coupled to one or more data processing systems.

Network 130 may be the Internet, a virtual private network, a local area network, a wide area network, a broadband digital network or any other network for enabling communication between two or more nodes or locations. Network 130 may include a shared, public, or private data network and encompass a wide area or local area. Network 130 may also include one or more wired or wireless connections, and may employ communication protocols such as Transmission Control and Internet Protocol, Asynchronous Transfer Mode), Ethernet, or any other compilation of procedures for controlling communications among network locations. Network 130 may also include or provide telephony services. In such embodiments, network 130 may include or leverage a Public Switched Telephone Network or leverage voice-over Internet Protocol technology.

In certain embodiments, network 130 may include or be coupled to one or more databases or other storage mechanisms with documents or other material of interest. Such databases and storage mechanisms may be stand-alone modules or may be distributed among one or more workstations and/or servers.

Various components may be operatively connected to network 130 by communication devices and software known in the art, such as those commonly employed by Internet Service Providers or as part of an Internet gateway. Such components may be assigned network identifiers (ID). As used herein, the term “ID” refers to any symbol, value, tag, or identifier used for addressing, identifying, relating, or referencing a particular element. Network IDs, for example, may include IP addresses.

Computing system 500 may include a number of components, such as a processor or central processing unit (CPU) 510, a memory 520, a network interface 530, one or more I/O devices 540, and/or a display 550. A system bus 560 may interconnect such components.

CPU 510 may include or leverage any suitable microprocessor, micro-, mini-, or mainframe computer. Memory 520 may include any system and/or mechanism capable of storing information. For example, memory 520 may include a random access memory, a read-only memory, magnetic and optical storage elements, organic storage elements, audio disks, and video disks. Also, memory 520 may include mass storage or cache memory such as fixed and removable media. Memory 520 may also provide a primary memory for CPU 510, including program code for communications; kernel and device drivers; configuration information, and other applications. Thus, memory 520 may contain an operating system, an application routine, a program, application 140, an application-programming interface, and/or other instructions for performing methods consistent with embodiments of the invention. Although a single memory is shown, any number of memory devices may be included in computing system 500, and each may be configured for performing distinct functions.

Network interface 530 may be any mechanism for sending information to and receiving information from network 130, such as a network card and an Ethernet port, or to any other network such as an attached Ethernet LAN, serial line, etc. Network interface 530 may include dial-up telephone and/or other conventional data port connections.

Computing system 500 may receive input via one or more input/output (I/O) devices 540. I/O device 540 may include components such as keyboard, a mouse, a pointing device, and/or a touch screen or information-capture devices, such as audio- or video-capture devices. For example, VO device 540 may include a microphone and be coupled to voice recognition software for recognizing and parsing utterances.

Computing system 500 may present information and interfaces (e.g., GUIs) via display 550. Display device 550 may be configured to display text, images, or any other type of information. Display device 550 may additionally or alternatively be configured to audibly present information. For example, display device 550 could include a speaker or some other audio output device, for providing audible sounds to a user. In fact, display device 550 may include or be coupled to audio software configured to generate synthesized or pre-recorded human utterances. In this way, display device 550 may be used in conjunction with I/O device 540 for facilitating user interaction.

Bus 560 may be a bidirectional system bus. For example, it could contain separate address lines and data lines. Alternatively, the data and address lines may be multiplexed.

Application 140 may comprise query parser module 610, document parser module 620, sentence filter module 630, document generator module 640, and static knowledge base 650. Application 140 may be implemented in software and reside in memory 520. Examples of systems and methods for retrieving relevant information may be found in co-pending U.S. patent application Ser. No. 09/869,579, filed Jun. 29, 2001, entitled “System and Method for Retrieving Information With Natural Language Queries,” which is incorporated herein by reference.

Query parser module 610 may include any mechanism, program, algorithm, or scheme for separating sequential information into segments that can be managed or used by another component. For example, query parser module 610 may be an XML parser. The task of query parser module 610 is to parse a query provided by the user into single words or other manageable portions. In some embodiments, query parser may also filter the query text by removing irrelevant words, such as words that do not specify particular content.

Query parser module 610 may also add to the query words that are semantically related to words in the query. The result of this process is a list (or table) of words that are either members of the original query or semantically related to members of the original query, such as synonyms.

To achieve a proper matching, inflected query words may be associated with those in a knowledge base using a heuristic matching algorithm. For example, if the word ‘cluster’ appears in the query, and ‘grouping’ is regarded as a synonym in, the heuristic algorithm must also make sure that words like “clustering” and “clusters” are referring to the same concept, which can be done by examining the context of the query. For the query “What are lymphoma symptoms?” query parser module 610 may remove the words “what” and “are.” Then, query parser module 610 may check for words related to lymphoma, such as “lymph” and “node” to extend the query to four words: lymphoma, lymph, node, and symptoms.

Document parser 620 may be implemented by software, hardware, firmware or any combination. Document parser 620 may parse documents into single words or appropriate portions, and assign every word or portion to a sentence and, possibly, a position within the sentence. The result of this process may be three lists or tables: a word presence list, a position list, and a sentence list. A word presence table may include two columns, where the first column in each row contains a word, the second a number denoting how many times the word occurred in the document. A position table may include three columns, where the first column or each row is a word, the second a sentence number in the document, and the third the position of this word in the sentence. A “position” may refer to a placement or orientation of a word or item in a document, or a logical orientation of an item in a document. A sentence table may include two columns, where the first column contains sentence numbers and the second the length of each sentence.

For example, consider a document with the following text:

Below are listed some symptoms:
One of the main symptoms is lymph node swelling, often in the upper
body area but it can be in almost any node or related lymph system organ.
Other symptoms include, a lack of energy, such as general fatigue, weight
loss, fevers that can come and go, night sweats, and itching.

For the word presence list, shown in part below, one row would correspond to the word “symptoms.” The first column would contain the word “symptom,” and in the second the number “3,” because this word appeared three times in the document.

WORD PRESENCE LIST

| WORD | # |
|---|---|
| symptoms | 3 |
| node | 2 |
| lymph | 2 |

While the word presence list shows the frequency of a word, the position list, shown in part below, shows the position of a word in the document. This list includes three entries for the word “symptoms,” two for “node,” and two for “lymph.”

POSITION LIST

| WORD | Sentence | Position |
|---|---|---|
| symptom | 1 | 5 |
| symptom | 2 | 5 |
| symptom | 3 | 2 |
| node | 2 | 8 |
| node | 2 | 23 |
| lymph | 2 | 7 |
| lymph | 2 | 26 |

The first entry, (symptom, 1, 5), indicates that the word “symptom” appears in sentence 1 in position 5.

The sentence list contains the length of the sentences, such as the number of words.

SENTENCE LIST

| SENTENCE | # |
|---|---|
| 1 | 5 |
| 2 | 28 |
| 3 | 23 |

Words having a semantic relation to words in sentences may be added to the tables and given a predefined relevance value or the same one derived from the word they have a relation to in the document. Such semantically related words may be derived using a knowledge base. Additional details of a knowledge base as well as such semantic relations and relevance values are discussed below.

Sentence filter 630 may filter or remove those sentences having no association to the topic presented in the query and rank those sentences according to how relevant they are to the topic. Sentence filter 630 may be implemented by one or more software, hardware, or firmware components.

Sentence filter 630 may begin by filtering sentences having no association with the search query. This may be performed by eliminating sentences having no words in the query, which may have been extended by query parser module 610. The remaining sentences contain words matching those of the query or having a semantic relation to those words. In the example presented, all of the sentences would be found to be relevant because one or more of the words from the query or words related to the query appear in each sentence.

The goal of relevance evaluation is to find the “n” most relevant sentences where “n” is the maximum number of sentences the user wants to have in the summary. Relevance can depend on the number of relevant words, the proximity of the words to one another, or any other appropriate metric. Relevancy determinations are well known in the art.

Document generator 640 generates a summary from the most relevant sentences to create the intermediary document 310A-310N or 360. Document generator 640 may be embodied by any mechanism, program, algorithm, or scheme. Summaries can list sentences in the order they appeared in the original document, or by relevance. The intermediary document may also include links from the sentence in the intermediary document to the origin of the sentence in the original document (See FIGS. 3A and 3B.) To facilitate the creation of the links, the original document may be copied and hypertext markups are inserted at positions of relevant sentences.

Knowledge base 650 may be embodied by various components, systems, networks, or programs. As used herein, the term “knowledge base” refers to any resource, facility, or lexicon, from which information can be obtained. A “knowledge base” may include an ontology, thesaurus, or dictionary, which can be used to identify semantic relations between words, such as words occurring in a search query, and possible synonyms and hypernyms. A knowledge base may include a list of words semantically related to words expected to be found in the documents being searched, like synonyms or hyponyms. A particular knowledge base may include information pertaining to particular subjects, such as numeric information, textual information, audible information, graphical information, etc. In one configuration, a knowledge base may include one or more structured data archives distributed among one or more network-based data processing systems.

In addition to containing semantic relations between words in an implicit (inferable) or explicit (retrievable) manner, a knowledge base may have explicit or implicit relevance values attached to words, which may serve in the evaluation of the relevance of portions of a document relative to a search query. Such relevance values (rvalues) may serve to calculate the relevance of the segment from a document in which they, or related words (synonyms, etc.), occur. If a knowledge base exists containing words semantically related to words in a document, those words can be incorporated and given a relevance value (rvalue) predefined in the knowledge base or derived from the word they have a relation to in the document.

In certain embodiments, application 140 may include a summary table for maintaining each search query result. In one configuration, the vocabulary of search queries may be maintained in a lookup table. This invention is not restricted or inherently related to any particular type of application 140 or number of modules in application 140. Also, this invention may be used with applications or search engines. As previously mentioned, application 140 may be implemented in software and may reside in a memory on a workstation. Application 140 can also be a plug-in.

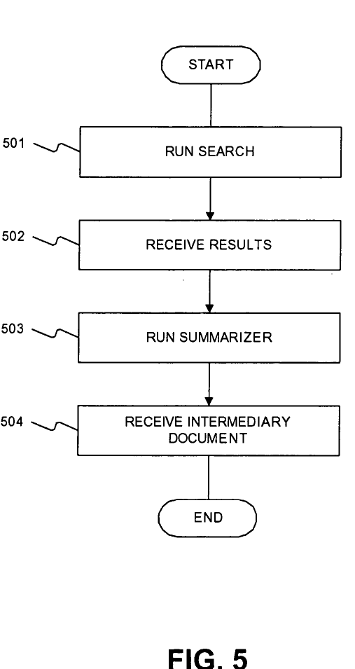

FIG. 5 is a flowchart of steps for creating a intermediary document. The method begins when a search is run (step 501), for example by a user initiating a search with a search query. The search query may be performed in a web browser using a standard search engine. In certain embodiments, the search query may be performed in an application as part of a “Help” option. The user can, for example, indicate a desired number of results.

A result list is received after a search is run (step 502). The result list may be displayed to the user via an interface or display (e.g., display 550). In response to the search query, the search engine may generate a set of search results or documents. The search engine may assign each search result a relevance score and return, for example, 10 or 20 of the highest scoring results in the result list.

Next, a summarizer (e.g., application 140) is run (step 503). The summarizer may run analysis steps on each search result document, and may parse the search result to separate the information in the search result document into segments that can be analyzed to determine their relevance. The relevant segments for each document may be put together into corresponding intermediary documents, or a single intermediary document can contain the relevant segments from several or all the documents.

Consistent with principles of the present invention, the relevant segments may include a link to their position in the original document. Such a link to the relevant position in the original document may be generated by creating a shadow or copy of the original document, that allows for the insertion of link tags. The link document may have embedded HTML position markers to allow for linking from the intermediary document to the relevant position in the original document.

Consistent with principles of the present invention, the intermediary document is received (step 504). The user may view a list of results, with links from the results to the intermediary document, the original document, or both.

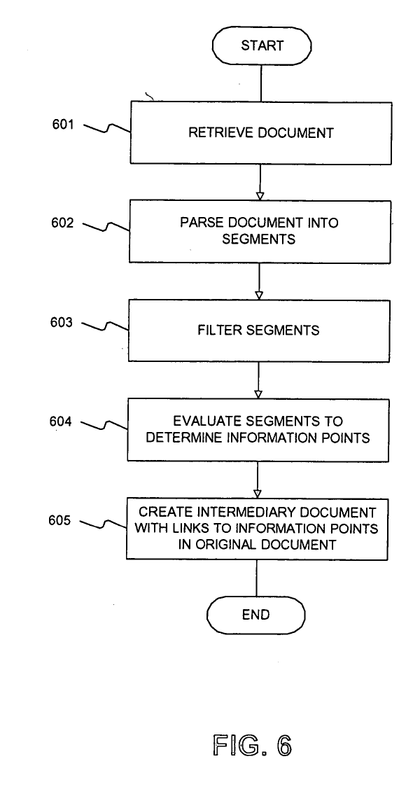

FIG. 6 is a flowchart of another method consistent with the invention for providing an intermediary document. First, a document is retrieved (step 601).

After the document is received, it may be parsed (step 602) by, for example, document parser 620. In parsing, the document is broken down into segments, such as sentences. The parsing may include the creation of relevance lists or charts, such as word presence lists, position lists or sentence lists, described above, to aid in the analysis of relevance. The lists or charts are based on the initial query, which may be analyzed to provide more insight into relevance. The query may also be filtered or extended to account for synonyms or other related words.

After parsing, the segments are filtered (e.g., by sentence filter 630) to remove those segments that include no relevant information (step 603). The remaining segments are evaluated to determine the most relevant segments (step 604). The most relevant segments are identified as information points. These information points are then used to create an intermediary document. An intermediary document may be created (e.g., by document generator 640) with links to information points in a document (step 605). This intermediary document may then be made available for the user to review.

For purposes of explanation only, certain aspects of the present invention are described herein with reference to the discrete functional elements illustrated in FIG. 4. The functionality of the illustrated elements and modules may overlap, however, and may be present in a fewer or greater number of elements and modules. Further, all or part of the functionality of the illustrated elements may co-exist or be distributed among several geographically dispersed locations. Moreover, embodiments, features, aspects and principles of the present invention may be implemented in various environments and are not limited to the illustrated environments.

The sequences of events described in FIGS. 5 and 6 are exemplary and not intended to be limiting. Thus, other method steps may be used, and even with the methods depicted in FIGS. 5 and 6, the particular order of events may vary without departing from the scope of the present invention. Moreover, certain steps may not be present and additional steps may be implemented in FIGS. 5 and 6. Embodiments consistent with the invention may be implemented in various environments. The processes described herein are not inherently related to any particular apparatus and may be implemented by any suitable combination of components.

The foregoing description of possible implementations consistent with the present invention does not represent a comprehensive list of all such implementations or all variations of the implementations described. The description of only some implementation should not be construed as an intent to exclude other implementations. Artisans will understand how to implement the invention in the appended claims in may other ways, using equivalents and alternatives that do not depart from the scope of the following claims. Moreover, unless indicated to the contrary in the preceding description, none of the components described in the implementations is essential to the invention.

1. A computer-implemented method for accessing relevant information in response to a search query, the method comprising:
receiving a document in response to the search query;
identifying relevant segments of the document reflecting a set of relevant words;
and generating an intermediary document including identifications of the relevant segments.

2. The method of claim 1, further including parsing the search query to create the set of relevant words.

3. The method of claim 2, wherein identifying the relevant segments includes:
parsing the document into segments;
generating a word presence list for each segment using the set of relevant words;
examining the segments based on the set of relevant words; and
ranking the segments by relevance.

4. The method of claim 1, wherein generating the intermediary document includes creating links from a relevant information point to a position of the relevant information point in the document.

5. The method of claim 1, further including the step of extending the list of relevant words using a knowledge base.

6. A data processing system for providing improved access to relevant information, comprising:
an acquisition module for retrieving information relating to a plurality of documents in response to a search query; and
a summarizing module for:
parsing the documents into segments;
selecting one of the segments as a relevant information point; and
generating an intermediary document identifying the selected relevant information point.

7. The system of claim 6, wherein the summarizing module is a software program.

8. The system of claim 7, wherein the software program is a plug-in.

9. The system of claim 6, wherein the intermediary document includes at least one of a plurality of links to specific locations in the search result documents.

10. The system of claim 6, wherein the application module is in a workstation.

11. The system of claim 6, wherein the application module is an interactive website.

12. An apparatus for generating an intermediary document of search results from an original document generated in response to a query, comprising:
a query parser for parsing a query to a search engine;
a document parser for parsing the original document into portions;
a relevance engine for evaluating the relevance of the portions in the original document; and
a document generator for generating the intermediary document using the evaluated portions.

13. The apparatus of claim 12, wherein the original document includes sentences, and
wherein the relevance engine includes a sentence filter for determining which of the sentences has relevant information.

14. The apparatus of claim 12, wherein the document generator comprises means for establishing links between portions of the intermediary document and corresponding portions in the original document.

15. The apparatus of claim 12, wherein the document parser is configured to generate at least one of a word presence list, a position list, and a sentence list,
wherein the word presence list indicates frequencies of words in the document, the position list indicates the position of words in the document, and the sentence list indicates the number of words in the document.

16. The apparatus of claim 12, wherein the query parser adds to the query words that are semantically related to words in the query.
